(19) United States
(12) Patent Application Publication
(10) Pub. No.: US 2018/0338599 A1
(43) Pub. Date: Nov. 29, 2018

(54) MIST PUMP OF COSMETIC CONTAINER

(71) Applicant: Jong Su LIM, Pocheon-si, Gyeonggi-do (KR)

(72) Inventor: Jong Su LIM, Pocheon-si, Gyeonggi-do (KR)

(21) Appl. No.: 15/757,778

(22) PCT Filed: Feb. 20, 2017
(86) PCT No.: PCT/KR2017/001858

§ 371 Date: Mar. 6, 2018

(30) Foreign Application Priority Data
Mar. 28, 2016 (KR) 10-2016-0036536

(51) Int. Cl. A45D 34/00; B05B 11/00; B05B 1/34

(52) U.S. Cl. CPC A45D 34/00; B05B 11/3001; A45D 2200/057; B05B 11/3025; B05B 1/3415

(57) ABSTRACT

A mist pump of a cosmetic container according to the present invention includes: a cap housing configured to be able to atomize contents by compressing external air introduced together with the contents in a cosmetic container and then discharging the contents in a whirlwind form by means of the compressed air; a piston housing; a compressing chamber formed between the cap housing and the piston housing; a piston formed to eject the compressed air and the contents while ascending; an opening and closing part that is formed between an inner surface of the piston housing and an outer surface of the piston, and through which the contents and the compressed air are ejected when the piston descends, and the external air is introduced into the compressing chamber when the piston ascends; and a pressurizing cap coupled to include an atomizing part that atomizes the contents by discharging the contents together with the compressed air in the whirlwind form through a nozzle passage formed in an upper end of the piston. Accordingly, the mist pump of the cosmetic container has the effects in that the mist pump may be used without being limited by the size of the cosmetic container, by virtue of external air compression, and a high level of stability can be achieved.

### TECHNICAL FIELD

The present invention relates to a mist pump of a cosmetic container, and more particularly, to a mist pump of a cosmetic container for providing contents by using compressed air after compressing external air introduced by pumping, instead of filling the cosmetic container with compressed gas together with contents, and especially for allowing the contents to be atomized while being discharged in the form of a whirlwind.

### BACKGROUND ART

In general, a cosmetic container used for storing and keeping cosmetics in a state of liquid or gel has a pumping unit on an inlet to smoothly discharge the contents to the outside.

Since the pump provided with the cosmetic container has a function to discharge the contents to the outside by a predetermined amount, various forms of structures are proposed and used to improve the convenience and reduce waste by restraining excessive discharge of contents.

A typical pump has a structure in which a check valve positioned at a content inlet is selectively opened and closed by a piston which vertically reciprocates according to a pumping operation of an upper cap in a state that the upper cap is assembled with an upper part of a lower cap coupled to an inlet of the container, such that the contents contained in the container are discharged to the outside through a nozzle by a predetermined amount.

The conventional arts related to a pump provided for pumping fluids having relatively high viscosity such as detergents and shampoos from the above cosmetic container have been disclosed in Korean Utility Model Registration No. 20-0312903, Korean Utility Model Registration No. 20-0327525, Korean Utility Model Registration No. 20-0459655 and so on.

The above pump provided for pumping fluids having relatively high viscosity has a relatively complicated structure for pumping the contents by high pressure and preventing leakage of the contents upon and after the pumping.

Meanwhile, the conventional arts related to a pump provided for pumping fluid contents such as mist, skin toner, perfume from a cosmetic container have been disclosed in Korean Utility Model Registration No. 20-0282747, Korean Utility Model Registration No. 20-0281927, Korean Patent Registration No. 10-1140380 and so on (Hereinafter, referred to as ‘Related Document’).

### RELATED DOCUMENT

(Patent Document 1) Korean Utility Model Registration No. 20-0312903

(Patent Document 2) Korean Utility Model Registration No. 20-0327525

(Patent Document 3) Korean Utility Model Registration No. 20-0459655

(Patent Document 4) Korean Utility Model Registration No. 20-0282747

(Patent Document 5) Korean Utility Model Registration No. 20-0281927

(Patent Document 6) Korean Patent Registration No. 10-1140380

### DISCLOSURE

### Technical Problem

However, in patent document 1, the cosmetic container is used after filling the cosmetic container with compressed gas together with the contents in order to pump and discharge liquid contents, thereby increasing the volume of the cosmetic container.

Accordingly, there is a limitation in use for a small cosmetic container, causing inconvenience of use.

Particularly, the user is also subject to the restriction that prohibits carrying a container filled with compressed gas when boarding an airplane or the like.

To solve the above conventional problems, the present invention provides a mist pump of a cosmetic container for providing contents by using compressed air after compressing external air introduced by pumping, instead of filling the cosmetic container with compressed gas together with contents, and especially for allowing the contents to be atomized while being discharged in the form of a whirlwind.

To solve the above problems, the present invention further provides a mist pump of a cosmetic container for facilitating the atomization of the contents.

### Technical Solution

To solve the above technical problems, the present invention includes: a cap housing coupled to an inlet of the cosmetic container; a piston housing coupled to an inside of the cap housing in which a tube, into which contents are introduced through a bottom surface of the tube, is coupled to the piston housing, a passage for accommodating a ball valve and a return spring is formed inside the piston housing, and a plurality of inlet/outlet holes through which external air is introduced and compressed air is discharged are formed at an upper portion of the piston housing; a compressing chamber formed between an inner surface of the cap housing and an outer surface of the piston housing to allow the external air to be introduced and compressed; a piston inserted into the piston housing and formed therein with a discharge passage connected to a plurality of intake holes formed in a lower portion of the piston, such that the compressed air and the contents are discharged while the piston is moving up and down; an opening and closing part formed between the inner surface of the piston housing and the outer surface of the piston, such that the contents and the compressed air are discharged when the piston descends, and the outside air is introduced into the compressing chamber when the piston ascends; and a pressurizing cap coupled to an upper end of the piston, formed thereon with a nozzle passage and including an atomizing part for atomizing the contents by discharging the contents with the compressed air in a form of a whirlwind.

The opening and closing part includes: an opening/closing protrusion formed on an outer surface of a lower end of the piston; and an opening/closing protrusion receiving groove formed at a lower portion of the inner surface of the piston housing to allow the opening/closing protrusion to be positioned in the opening/closing protrusion receiving groove when the piston descends, such that a passage and the discharge passage are connected to each other.

The atomizing part includes: a discharge port forwardly formed in front of the nozzle passage; a plurality of spraying passages formed at an inner rear side of a surface where the discharge port is formed and having shapes corresponding to each other with a predetermined angle; a nozzle cap fixed by the pressurizing cap and formed on side surfaces thereof with a plurality of guide passages so as to be connected to the spraying passages; and a closing cap fixedly coupled to an opposite side of the discharge port of the nozzle cap, and formed therein with a plurality of through-holes, such that the compressed air and the contents from the nozzle passage are introduced into the guide passages.

The discharge port includes an inclined surface formed to allow the compressed air and the contents supplied from various directions to be swirled in the form of a vortex, mixed and discharged through the spraying passages.

### Advantageous Effects

According to the present invention, the contents are provided by using compressed air after compressing external air introduced by pumping, instead of filling the cosmetic container with compressed gas together with contents, and particularly, the contents are atomized while being discharged in the form of a whirlwind, such that the contents can be used regardless of the size of the cosmetic container due to restriction caused by external air compression and the safety can be improved.

In addition, the contents can be uniformly discharged to a relatively far distance by discharging the atomized contents in the form of a whirlwind.

In addition, the atomization of the contents is further facilitated, so that the user can further conveniently use the contents.

### DESCRIPTION OF DRAWINGS

FIG. 1 is a sectional view for describing the present invention.

FIG. 2 is a sectional view of a state in use for illustrating that the contents according to FIG. 1 are discharged.

FIG. 3 is a partial cutaway perspective view for describing a nozzle cap of an atomizing part according to FIG. 1.

FIG. 4 is a cross sectional view according to FIG. 3.

### BEST MODE

[Mode for Invention]

Hereinafter, preferred embodiments of the present invention will be described in detail with reference to the accompanying drawings, and the present invention is not limited to or restricted by the embodiments.

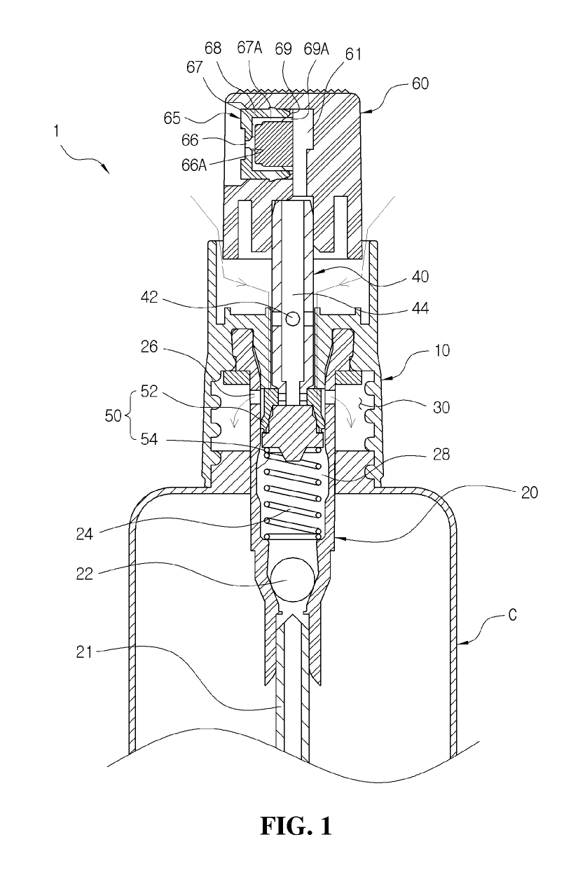

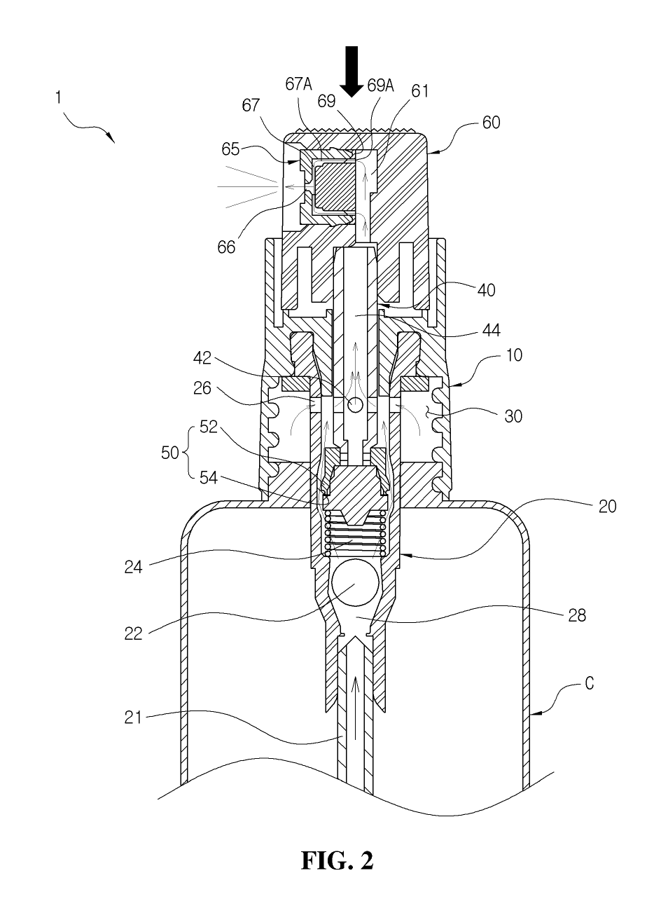

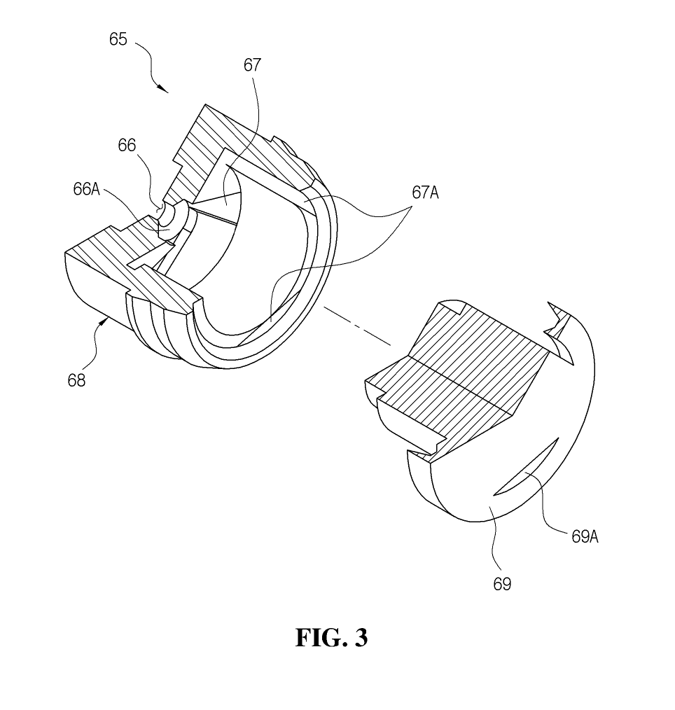

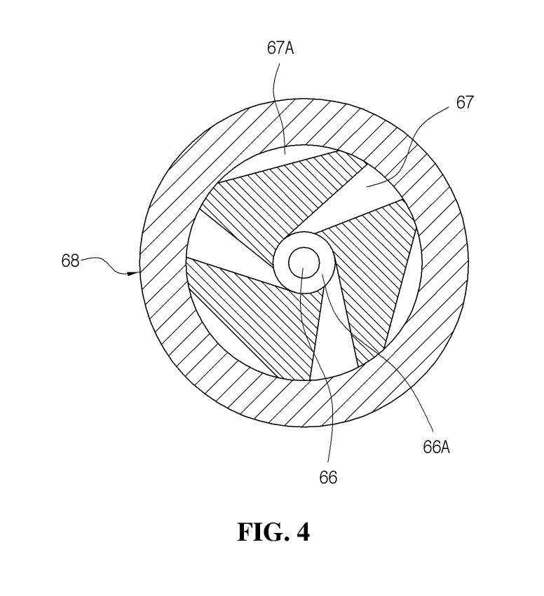

FIG. 1 is a sectional view for describing the present invention. FIG. 2 is a sectional view of a state in use for illustrating that the contents according to FIG. 1 are discharged. FIG. 3 is a partial cutaway perspective view for describing a nozzle cap of an atomizing part according to FIG. 1. FIG. 4 is a cross sectional view according to FIG. 3.

As shown in the drawings, there is proposed a pump 1 for pumping liquid contents such as mist, skin toner, and perfume from a general cosmetic container to discharge the contents in an atomized state.

According to the present invention, the contents are provided by using compressed air after compressing external air introduced by pumping, instead of filling the cosmetic container with compressed gas together with contents, and particularly, the contents are atomized while being discharged in the form of a whirlwind.

The pump 1 according to the present invention includes: a cap housing 10 coupled to an inlet of a cosmetic container C by a usual screw-coupling scheme or a one-touch scheme; a piston housing 20 coupled to an inside of the cap housing 10 in which a tube 21 into which the contents introduced is coupled to a bottom of the piston housing, a passage 28 accommodated therein with a ball valve 22 and a return spring 24 is formed inside the piston housing, and a plurality of inlet/outlet holes 26 through which external air is introduced and compressed air is discharged are formed on an upper portion of the piston housing; a compressing chamber 30 formed between an inner surface of the cap housing 10 and an outer surface of the piston housing 20 to allow the external air to be introduced and compressed; and a piston 40 inserted into the piston housing 20 and formed therein with a discharge passage 44 connected to a plurality of intake holes 42 formed in a lower portion the piston 40, such that the compressed air and the contents are discharged while the piston moves up and down.

The piston housing and the piston are assembled with each other in such a general manner that the piston is inserted into a groove formed on an upper portion of the general piston housing.

The compressing chamber is formed between the cap housing and the piston housing and between the cap housing and the upper end of the cosmetic container coupled to the cap housing.

A lower portion of the piston is inserted into the passage of the piston housing, and a support unit is fixedly coupled to the bottom surface of the piston, such that the support unit can be abutted and supported against the return spring.

In addition, The pump 1 includes: an opening and closing part 50 formed between the inner surface of the piston housing 20 and the outer surface of the piston 40, such that the contents and the compressed air are discharged when the piston 40 descends, and the outside air is introduced into the compressing chamber 30 when the piston 40 ascends; and a pressurizing cap 60 coupled to an upper end of the piston 40 to form a nozzle passage 61 and include an atomizing part 65 for atomizing the contents by discharging the contents in the form of a whirlwind together with the compressed air.

The opening and closing part 50 includes: an opening/closing protrusion 52 formed on an outer surface of a lower end of the piston 40; and an opening/closing protrusion receiving groove 54 formed at a lower portion of the inner surface of the piston housing 20 to allow the opening/closing protrusion 52 to be positioned in the opening/closing protrusion receiving groove 54 when the piston 40 descends, such that a passage 28 and the discharge passage 44 are connected to each other. Herein, the opening/closing protrusion may be integrally formed at the lower end of the piston, and as shown in the drawings, it is preferable that the opening/closing protrusion is separately manufactured to be formed on a ring housing and fixed to the lower end of the piston by using a conventional scheme.

The atomizing part 65 includes: a discharge port 66 forwardly formed in front of the nozzle passage 61; a plurality of spraying passages 67 formed at an inner rear side of a surface where the discharge port 66 is formed and having shapes corresponding to each other with a predetermined angle; a nozzle cap 68 fixed by the pressurizing cap 60, and formed on side surfaces thereof with a plurality of guide passages 67A so as to be connected to the spraying passages 67; and a closing cap 69 fixedly coupled to an opposite side of the discharge port 66 of the nozzle cap 68, and formed therein with a plurality of through-holes 69A, such that the compressed air and the contents from the nozzle passage 61 are introduced into the guide passages 67A.

In other words, the spraying passages have predetermined angles like a pinwheel around protrusion sills and discharge port between the protrusion sills that protrude from the rear surface, so that the compressed air and the contents introduced through the guide passage are discharged in the form of a whirlwind through the discharge port. Herein, the compressed air and the contents are discharged in the form of a whirlwind due to the discharge pressure while being atomized by collision through the spraying passages.

In addition, the guide passage is formed at the side surface of the nozzle cap in the form of a general guide groove for smoothly guiding the contents to the spraying passages, so that the compressed air and the contents passing through the nozzle passage may be smoothly guided to the spraying passages through the guide passage.

Further, the atomizing part is composed of the nozzle cap and the closing cap such that moldability and processability can be improved. In other words, the nozzle cap is formed in a separated shape so that the spraying passage and the guide passage that are formed according to the nozzle cap can be easily processed or molded.

In addition, the nozzle cap may be assembled with the pressurizing cap by using general protrusions and grooves, and also may be assembled by a known screw-coupling scheme or the like.

In addition, the discharge port 66 includes an inclined surface 66A formed to allow the compressed air and the contents supplied from various directions to be swirled in the form of a vortex, mixed and discharged through the spraying passages.

In other words, a region bordering the spraying passage of the discharge port is formed in an inclined surface, such that the compressed air and the contents moving through the spraying passages collide with each other along the inclined surface, thereby being discharged while rotating in the form of a whirlwind more smoothly together with atomization.

Accordingly, the atomized contents discharged while rotating in the form of a whirlwind are discharged to the farther distance, such that the contents can be uniformly distributed to the user.

According to the present invention configured in the above manner, at first, the outside air introduced between the gap between the pressurizing cap and the cap housing and the gap between the piston and the piston housing is introduced into the compressing chamber through the inlet/outlet hole formed in the piston housing.

The outside air introduced into the compressing chamber is compressed by the piston descending in the piston housing together with the pressure of the pressurizing cap, wherein the opening/closing protrusion of the opening and closing part descends while abutting against the inner surface of the piston housing.

When the opening/closing protrusion is positioned at the opening/closing protrusion receiving groove of the piston housing while the piston descends, the passage and the discharge passage are connected to each other, and the inlet/outlet hole and the intake hole are placed at a position corresponding to each other, so that the compressed air in the compressing chamber is discharged through the inlet/outlet hole, the intake hole, the discharge passage, the nozzle passage, and the guide passage, the spraying passage and the discharge port of the atomizing part. Herein, in the process of moving and discharging the compressed air, the contents introduced into the tube and the passage are also mixed with the compressed air due to the discharge pressure, atomized by the atomizing part while being discharged through the same path as the compressed air, and discharged.

With regards to the atomization of the contents through the atomizing part, the compressed air and the contents passing through the through-hole of the closing cap from the nozzle passage pass the guide passage, and are atomized while colliding with each other in the form of a whirlwind by the spraying passages formed at predetermined angles toward the discharge port, thereby being discharged to the discharge port by the rotational force.

Accordingly, the atomized contents can be discharged to a relatively far distance by the rotational force for rotating the contents in the form of a whirlwind.

Further, in the process of discharging the compressed air and the contents by the inclined surface formed on the discharge port, the compressed air and the contents moving through the spraying passages collide with each other along the inclined surface, thereby being discharged while rotating in the form of a whirlwind more smoothly together with the atomization, such that the atomized contents can be discharged to the farther distance.

Thus, according to the present invention, in the process of discharging the contents in an atomized state, the external air is introduced and compressed by the pumping operation, instead of using compressed gas, and then the contents are atomized and discharged through the atomizing part by the compressed air, so that the contents can be used without restriction on the size of a cosmetic container.

In addition, in the process of atomizing and discharging the contents, the contents are discharged in the form of a whirlwind, so that the contents can be uniformly discharged to a relatively far distance.

1. A mist pump of a cosmetic container, the mist pump comprising:
a cap housing coupled to an inlet of the cosmetic container;
a piston housing coupled to an inside of the cap housing in which a tube, into which contents are introduced through a bottom surface of the tube, is coupled to the piston housing, a passage for accommodating a ball valve and a return spring is formed inside the piston housing, and a plurality of inlet/outlet holes, through which external air is introduced and compressed air is discharged, are formed at an upper portion of the piston housing;
a compressing chamber formed between an inner surface of the cap housing and an outer surface of the piston housing to allow the external air to be introduced and compressed;
a piston inserted into the piston housing and formed therein with a discharge passage connected to a plurality of intake holes formed in a lower portion of the piston, such that the compressed air and the contents are discharged while the piston is moving up and down;
an opening and closing part formed between the inner surface of the piston housing and the outer surface of the piston, such that the contents and the compressed air are discharged when the piston descends, and the outside air is introduced into the compressing chamber when the piston ascends; and
a pressurizing cap coupled to an upper end of the piston, formed thereon with a nozzle passage and including an atomizing part for atomizing the contents by discharging the contents with the compressed air in a form of a whirlwind.

2. The mist pump of claim 1, wherein the opening and closing part comprises:
an opening/closing protrusion formed on an outer surface of a lower end of the piston; and
an opening/closing protrusion receiving groove formed at a lower portion of the inner surface of the piston housing to allow the opening/closing protrusion to be positioned in the opening/closing protrusion receiving groove when the piston descends, such that a passage and the discharge passage are connected to each other.

3. The mist pump of claim 1, wherein the atomizing part comprises:
a discharge port forwardly formed in front of the nozzle passage;
a plurality of spraying passages formed at an inner rear side of a surface where the discharge port is formed and having shapes corresponding to each other with a predetermined angle;
a nozzle cap fixed by the pressurizing cap and formed on side surfaces thereof with a plurality of guide passages so as to be connected to the spraying passages; and
a closing cap fixedly coupled to an opposite side of the discharge port of the nozzle cap, and formed therein with a plurality of through-holes, such that the compressed air and the contents from the nozzle passage are introduced into the guide passages.

4. The mist pump of claim 3, wherein the discharge port comprises an inclined surface to allow the compressed air and the contents supplied from various directions through the spraying passages to be discharged after being mixed in a form of a vortex.
